(19) United States
(12) Patent Application Publication
(10) Pub. No.: US 2006/0292518 A1
(43) Pub. Date: Dec. 28, 2006

(54) Digital intra-oral imaging device

(76) Inventor: Yueh-Shing Lee, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/159,929

(22) Filed: Jun. 23, 2005

(51) Int. Cl. A61C 3/00

(52) U.S. Cl. 433/29

(57) ABSTRACT

A digital intra-oral imaging device comprises a hollow front part body and a rear part body connected to the front part body. The front part body has an opening defined in the front portion thereof and a circular recess defined in and around the internal circumference wall of the rear portion thereof. A reflector and a light emitting device are disposed above the opening inside the front portion. The rear part body consists of a front tube body and a rear tube body each having a through hole. An elastic latch is inserted in the front and rear tube bodies and has two latch hooks extending through the through holes respectively. The latch hook that is extended from the front tube body is then wedged in the circular recess of the front part body, thereby detachably and rotatably connecting the front part body and the rear part body.

### BACKGROUND OF THE INVENTION

1. Field of the Invention

The present invention relates generally to an imaging device, and more especially to a digital intra-oral imaging device for taking images in the oral cavity.

2. The Related Art

In recent years, during dental surgery, or in dental surgical department or the like, the art has advanced from medical treatment to prevention. A preventive medical examination first requires an understanding of the state of the oral cavity, an image of the interior of the oral cavity has been taken by using an intra-oral imaging device such as a CCD to be an image sensor, and the photograph has been preserved as a record.

Conventionally, an intra-oral imaging device, as disclosed in U.S. Pat. No. 5,784,434 comprises a body, a head connected to the body, means for displaying the visible image recorded by a pickup, a source of x-rays, and a controller operable connected with the display means.

However, the intra-oral imaging device described above needs to be provided with extra light source such as x-rays, and it is troublesome to use the intra-oral imaging device when to take images in the oral cavity in different directions for the head being fixed to the body. Additionally, the intra-oral imaging device is not suitable for being widely used because of their complex structure and high cost. Accordingly, there is a clear need in the art for a simple, low cost imaging device for dental examination which can be manufactured using readily available, low cost components. The present invention is directed towards satisfying this need.

### SUMMARY OF THE INVENTION

It is an object of the present invention to provide a digital intra-oral imaging device with simple structure, low cost and suitable for widespread use.

To fulfill the above objects, the digital intra-oral imaging device comprises a hollow front part body, a rear part body detachable connected to the front part body, and an elastic latch disposed in the rear part body. The rear part body adapted to be held by an operator has a front tube body and a rear tube body. Two through holes are defined in the front tube body and the rear tube body and opening to the same direction. The elastic latch has two latch hooks protruded from opposite ends thereof. The elastic latches are inserted in the front tube body and the rear tube body with the two latch hooks extending through the two through holes. The hollow front part body adapted to be disposed in an oral cavity has an opening defined in a side of the front portion thereof and a circular recess disposed in and around the internal circumference wall of the rear portion thereof. The front tube body of the rear part body is inserted in the rear portion of the hollow front part body with the latch hook that is extended from the front tube body wedged in the circular recess for detachable and rotatable connecting the hollow front part body and the rear part body. A light emitting component is positioned above the opening in the interior of the front portion of the front part body for illuminating the oral cavity. A reflector is positioned above the opening in the interior of the front portion of the front part body. An optical lens is positioned in the interior of the rear part body. Light from the oral cavity passes through the opening and is reflected by the reflector to the optical lens. The optical lens converges the reflected light and images an image of the oral cavity. An image pickup device is positioned in the interior of the rear part body and located behind the optical lens for recording the image of the oral cavity.

Structured and functioned as mentioned above, the present digital intra-oral imaging device is simple in structure, low in cost and easy-to-use.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is an exploded perspective view of a preferred embodiment of a digital intra-oral imaging device according to the present invention;

FIG. 2 is a cross-section view illustrating a front part body and a rear part body of the digital intra-oral imaging device being detached;

FIG. 3 is a cross-section view illustrating the front part body and the rear part body of the digital intra-oral imaging device being connected;

FIG. 4 is an assembled perspective view of the digital intra-oral imaging device;

FIG. 5 is another assembled perspective view of the digital intra-oral imaging device;

FIG. 6 is another assembled perspective view of the digital intra-oral imaging device showing the front part body being rotated an angle relative to the rear part body; and

FIG. 7 is a partial enlarged view of the encircled portion designated VII in FIG. 2.

### DETAILED DESCRIPTION OF THE PREFERRED EMBODIMENT

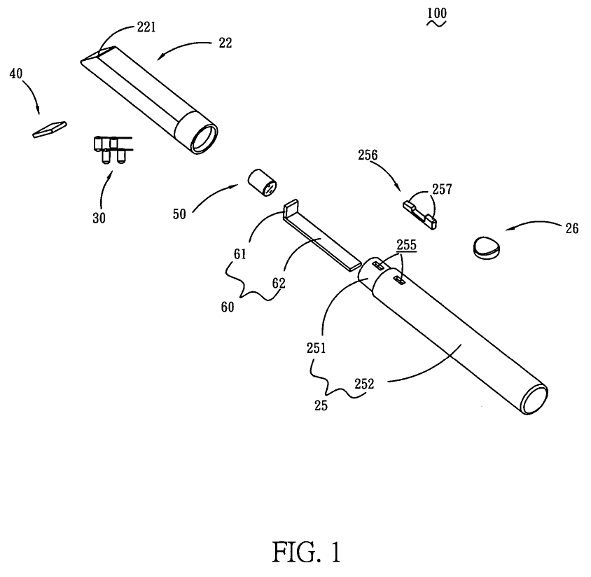

With reference to FIG. 1, a digital intra-oral imaging device 100 comprises a hollow front part body 22 adapted to be disposed in the oral cavity, a rear part body 25 and an elastic latch 256 disposed in the rear part body 25. A light emitting component 30 and a reflector 40 are disposed in the front part body 22. An optical lens 50 and an image pickup device 60 are disposed in the rear part body 25. It will be appreciated that, alternatively, the optical lens 50 can be disposed in the front part body 22.

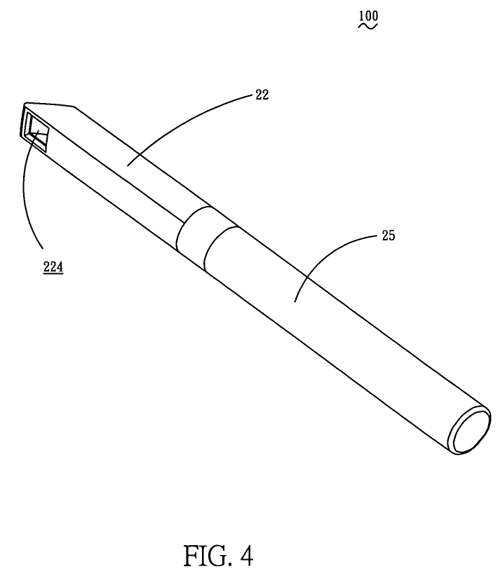

Referring to FIG. 2, the front tip end of the hollow front part body 22 is slanted to be an inclined plane 221. An opening 224 is defined in a side of the front part body 22 opposite to the inclined plane 221 (as shown in FIG. 4). In this preferred embodiment, the inclined plane 221 is inclined to be 45° angles related to the axis of the front part body 22. A circular recess 227 is defined in and around the internal circumference wall of the rear portion of the front part body 22.

Referring to FIG. 1 and FIG. 2, the rear part body 25 adapted to be held by an operator is consist of a front tube body 251 and a rear tube body 252. The external diameter L1 of the front tube body 251 is smaller than the external diameter L2 of the rear tube body 252. The external diameter L1 is identical with the internal diameter L3 of the rear portion of the front part body 22. Two through holes 255 are defined in the front tube body 251 and the rear tube body 252 respectively and open to the same direction. The elastic latch 256 has two latch hooks 257 protruded from two opposite ends. The elastic latch 251 is inserted in the rear part body 25 with the two latch hooks 257 extending through and protruding outside from the two through holes 255.

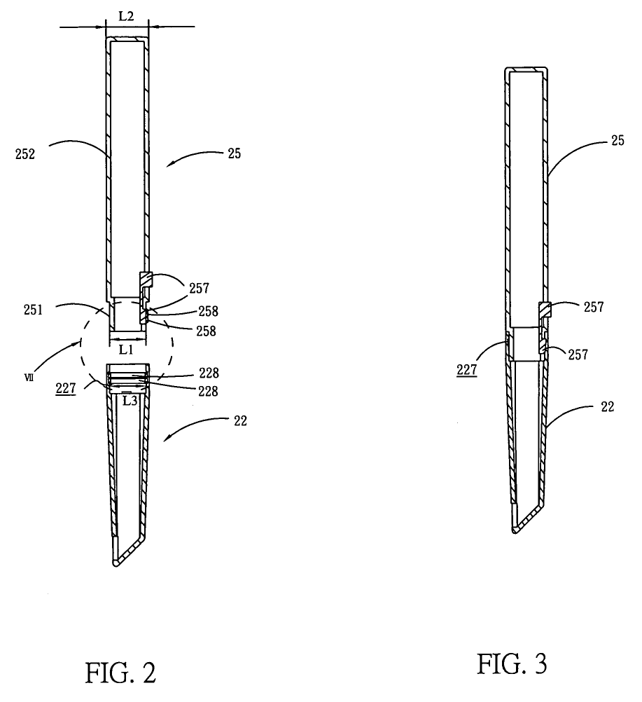

Referring to FIG. 3, when connecting the rear part body 25 to the front part body 22, depressing the rear latch hook 257 of the elastic latch 256, the front latch hook 257 is receded towards the interior of the rear part body 25. Then, pushing the rear part body 25, the front tube body 251 of the rear part body 25 enters the interior of the rear portion of the hollow front part body 22, and do not releasing the rear latch hook 257 until the front latch hook 257 is slid into the circular recess 227. After releasing the rear latch hook 257, both the front and rear latch hooks 257 are relaxed and recovered to extend outward. The latch hook 257 extended from the front tube body 251 wedges in the circular recess 227. Therefore, the hollow front part body 22 detachably and rotatably connects to the rear part body 25 with the elastic latch 256. The latch hook 257 abuts against and engages with the internal surface of circular recess 227, and the rear part body 25 is rotated related to the hollow front part body 22.

When to detach the hollow front part body 22 from the rear part body 25, depress the latch hook 257 extended through the rear tube body 252 again and pull the rear part body 25 until the latch hook 257 extended through the front tube body 251 is separated from the circular recess 227. Accordingly, the rear part body 25 is disassembled from the hollow front part body 22. As described above, the circular recess 227 cooperating with the latch hooks 257 of the elastic latch 256 achieves the detachably connecting of the front and rear part bodies 22, 25, so the structure is simple, and the operation of assembling/disassembling and using is convenient and easy.

Again with reference to FIG. 1, the reflector 40 is disposed in the interior of the front portion of the hollow front part body 22 and located above the opening 224. In this preferred embodiment, the reflector 40 is embedded in the inner surface of the inclined plane 221 and is a plane mirror.

The light emitting component 30 as a light source is located above the opening 221 and disposed in the interior of the front portion of the hollow front part body 22. The light emitting component 30 throws illuminating light through the opening 224 for illuminating the oral cavity, and the illuminating light is reflected from the oral cavity to the reflector 40 through the opening 224. In this preferred embodiment, the light emitting component 30 employs four LEDs disposed around the reflector 40.

The optical lens 50 and the image pickup device 60 are disposed in the rear part body 25 in turn. The image pickup device 60 is located behind the optical lens 50 and the optic axis of the optical lens 50 is parallel with the axis of the rear part body 25. The image pickup device 60 comprises image sensors 61 and image processing circuit. The image processing circuit is integrated on a circuit board 62. In this preferred embodiment, CCD sensors are applied as the image sensors 61 for image pickup. The CCD sensors are connected to the circuit board 62. Light from the oral cavity passes through the opening 224 and is further reflected by the reflector 40 to the optical lens 50. The optical lens 50 converges the reflected light to the CCD sensors and images an image of the oral cavity. The CCD sensors receive and record the image of the oral cavity to convert into electrical signals. The image processing circuit processes the electrical signals from the CCD sensors to be digital image data. The circuit board 62 further comprises a data transmission control circuit and a data transmission interface for transmitting the image data to an outer display and further to display the images. A press button 26 is disposed on the rear tube body 252 and electrically connected to the circuit board 62. The images of the oral cavity are captured and recorded while the press button 26 is pressed.

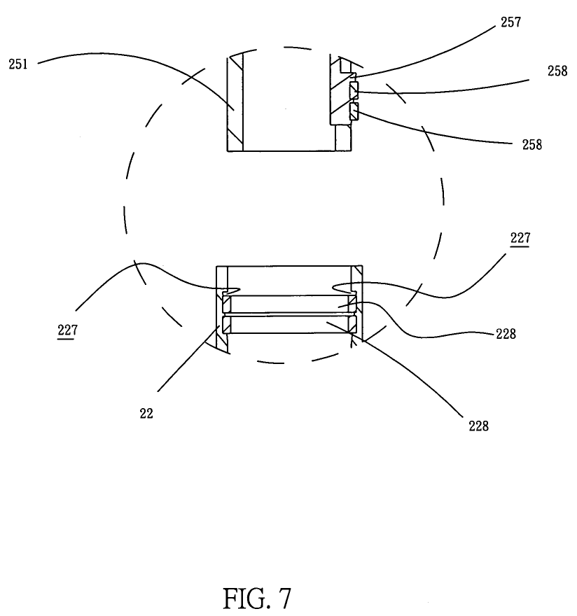

Referring to FIG. 2 and FIG. 7, in this preferred embodiment, the front part body 22 further comprises two circular conductive rings 228 disposed in the circular recess 227. The two circular conductive rings 228 connect to the light emitting device 30. Two conductive spring contacts 258 are embedded in the latch hook 256 extending from the front tube body 251. The conductive spring contacts 258 are connected to the image processing circuit. When the latch hook 257 is wedged in the circular recess 227, the circular conductive rings 228 contact the conductive spring contacts 258, thereby electrically connecting the light emitting component 30 and the image pickup device 60. Thus, the light emitting device 30 obtains power supply from the image process circuit. It will be appreciated that, alternatively, an independent power supply can be used, for example, an alkaline battery, a lithium battery and a charging type battery, and a combination of a detachable battery pack and charger may also be used.

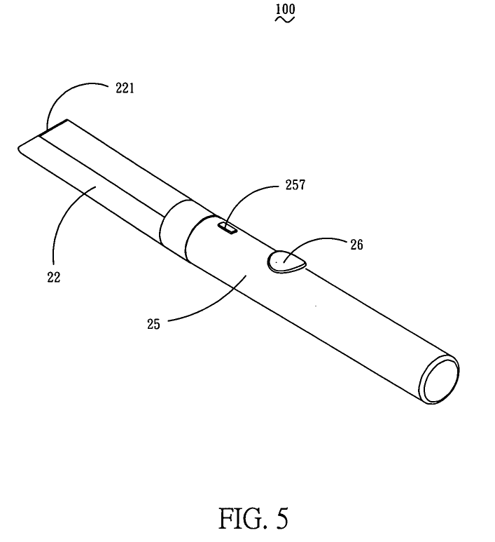

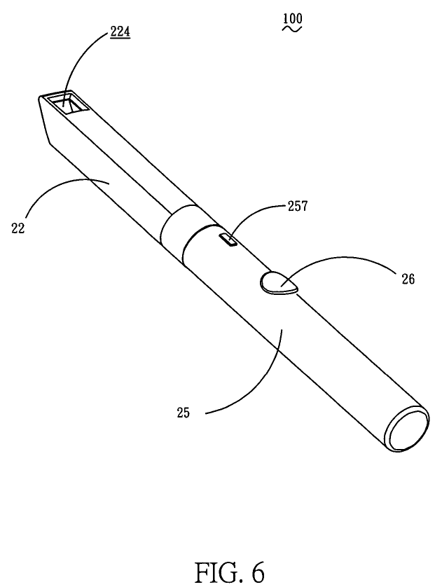

Referring to FIGS. 3-6, the latch hook 257 is rotatable around the internal circumference wall of the hollow front part body 22 in the circular recess 227, thereby enabling the rear and hollow front part bodies 25, 22 to be rotated relative to each other at an arbitrary angle of 360° angles. Therefore, it is convenient for operators to capture images in the oral cavity in different directions. In FIG. 4, for the requirement of taking images of sides of the oral cavity, the hollow front part body 22 is rotated with the opening 224 towards sideward, and then the press button 26 is pressed so as to capture the image. When take images of the bottom of the oral cavity, the opening 224 of the hollow front part body 22 is rotated toward downward, and then press the press button 26 so as to capture the image, as shown in FIG. 5. When the top of the oral cavity is required to be imaged, the hollow front part body 22 is rotated toward upward, as shown in FIG. 6.

As described above, the digital intra-oral imaging device 100 is constructed of simple components with low cost. The rear part body 25 is conveniently rotated relates to the hollow front part body 22 and is easy to be detached from the hollow front part body 22 for cleaning, maintenance and replace. Thus, the digital intra-oral imaging device 100 is suitable for operation and wide spread use.

Although a preferred embodiment of the present invention has been described in detail hereinabove, it should be clearly understood that many variations and/or modifications of the basic inventive concepts herein taught which may appear to those skilled in the present art will fall within the spirit and scope of the present invention, as defined in the appended claims.

What is claimed is:

1. A digital intra-oral imaging device comprising:
a rear part body adapted to be held by an operator, having a front tube body and a rear tube body, two through holes being defined in the front tube body and the rear tube body and opening to the same direction;
an elastic latch having two latch hooks protruded from opposite ends thereof, the elastic latch being inserted in the front tube body and the rear tube body with the two latch hooks extending through said two through holes;
a hollow front part body adapted to be disposed in an oral cavity, having an opening defined in a side of the front portion thereof and a circular recess disposed in and around the internal circumference wall of the rear portion thereof, the front tube body of said rear part body being inserted in the rear portion of the hollow front part body with the latch hook that is extended from the front tube body wedged in the circular recess, thereby detachably and rotatably connecting the hollow front part body and the rear part body;
a light emitting component positioned above the opening in the interior of the front portion of the front part body for illuminating the oral cavity;
a reflector positioned above the opening in the interior of the front portion of the front part body;
an optical lens positioned in the interior of the rear part body, light from the oral cavity passing through said opening and being reflected by said reflector to the optical lens, the optical lens converging the reflected light and imaging an image of the oral cavity; and
an image pickup device positioned in the interior of the rear part body and located behind the optical lens for recording the image of the oral cavity.

2. The digital intra-oral imaging device as claimed in claim 1, wherein said light emitting component comprises four LEDs being disposed around said reflector.

3. The digital intra-oral imaging device as claimed in claim 1, wherein said image pickup device comprises an image processing circuit and image sensors connected to the image processing circuit.

4. The digital intra-oral imaging device as claimed in claim 3, wherein said rear part body has a press button disposed on said rear tube body and connected to the image processing circuit.

5. The digital intra-oral imaging device as claimed in claim 3, further comprising two circular conductive rings disposed in the circular recess and electrically connected to the light emitting component, and two conductive spring contacts embedded in the latch hook that extends from the front tube body wedged in the circular recess and electrically connected to the image processing circuit, the circular conductive rings contacting the conductive spring contacts when the latch hook is wedged in the circular recess, thereby electrically connecting the light emitting component and the image pickup device.
